(19) United States
(12) Patent Application Publication
(10) Pub. No.: US 2011/0217434 A1
(43) Pub. Date: Sep. 8, 2011

(54) Pizza Press And Method Of Making A Pizza

(76) Inventor: Shane P. Brady, Plattsburg, MO (US)

(21) Appl. No.: 13/041,493

(22) Filed: Mar. 7, 2011

Related U.S. Application Data
(60) Provisional application No. 61/310,800, filed on Mar. 5, 2010.

(51) Int. Cl. A47J 37/01; A21D 13/00; A21D 8/02

(52) U.S. Cl. 426/292; 99/432; 426/389; 426/296

(57) ABSTRACT

A device and method of using the device for preparing and baking pizzas. The device separates slices of pizza from each other and prevents ingredients from mixing or migrating across slices during preparation and cooking of the pizza.

### CROSS-REFERENCE TO RELATED APPLICATIONS

This application claims benefit under 35 U.S.C. §119(e) to provisional U.S. patent application 61/310,800, filed Mar. 5, 2010. The entire contents of the aforementioned provisional application are incorporated herein by reference.

### TECHNICAL FIELD

The present invention relates generally to culinary utensils, and more specifically to pizza-making utensils.

### BACKGROUND

Anyone who has made a pizza understands that cutting baked and unbaked pizzas is a messy process and is damaging to the pizza. For example, especially with cooked/baked pizzas, it is difficult to cut the pizza without having runoff of sauce, cheese, grease, toppings or the like. As a result, additional time and labor for clean-up is required. Cutting a cooked/baked pizza can result in cheese, sauce, toppings, and the like, being moved to unintended locations. This can result in slices of pizza that are devoid of cheese, sauce, toppings, or the like.

Unintentionally moving toppings to a location on the pizza where they were not intended can result in the slice of pizza tasting differently than expected, decreasing enjoyment of the pizza for the individual with that particular slice. In addition to the aforementioned problems with cutting a pizza in general, if cut with a knife or conventional cutting wheel, there is the problem that all of the slices will not be even.

An additional, complicating factor is that people typically want different toppings on their slice or slices of pizza. Due to this complication, making a pizza for more than one person requires a certain amount of guessing when placing toppings at locations on the pizza, based on where the pizza maker intends to cut individual slices. Even with the most accurate and precise guessing at where the slices will be cut, flavors from various toppings and oils expand or migrate from their original locations to unintended places on the pizza during the cooking/baking process. The result is often not only uneven slices, as the slices are cut to include the toppings desired by each person, but also slices with unintended tastes, due to the oils and flavors expanding from the toppings.

Alternatively, a single pizza is made, with toppings added to individual slices afterwards. Each slice, with its corresponding toppings, is then reheated. This causes the toppings to blend with, for example, the cheese, sauce, and any other toppings previously on the slice. The reheated slices typically do not taste as good as slices taken from a freshly cooked/baked pizza.

### SUMMARY OF THE INVENTION

Throughout this document, the terms “cooking” and “baking”, and all verb and adjective forms thereof, are used interchangeably.

The presently disclosed device and method improves on conventional pizza-making devices and methods. It provides for making a pizza in a neat and organized manner. It also allows for individual slices to be made with toppings specific to each individual slice. Additionally, when the pizza is baked, the pizza is already divided and cut into individual slices.

The device and method improve upon the conventional process of creating pizza slices from a freshly-cooked pizza. According to the present invention, once the pizza is baked, it is ready for consumption in separate slices. The toppings of the slices are not disturbed by a subsequent cutting process. Throughout the preparation and baking processes, each slice retains its own integrity and the slices are even in size. Since each slice is prepared individually, each slice can have its own unique set of toppings.

The device and method of the present invention creates slices on an uncooked pizza and keeps slices away from each other during the cooking/baking process. Because the device is used on uncooked dough, the metal of the device typically does require sharpening or maintenance by treatments other than normal washing.

Disclosed is a pizza baking device that allows one to bake pre-sliced pizzas without the need to cut the pizza into slices after baking it. The device is constructed out of stainless steel and welded together in such a form that it can be pressed into slices of uncooked pizza dough. The device remains with the pizza from preparation, through baking/cooking, and results in individual-cooked pizza slices. However, though the slices are physically separated from each other, they are all baked simultaneously, as part of an entire pizza. Thus, the process of using the device is more efficient in terms of time and energy than cooking each slice individually and sequentially. This is beneficial not only in terms of time and energy cost, but also in optimizing the taste. Every slice of the pizza is baked at the same time, so the constituent parts of the entire pizza can all be freshly-baked when the time comes to eat the pizza.

The device and associated method of use are employed prior to and during the baking process. As a result of the disclosed device and method, pizza slices, for example, eight slices, are cooked individually allowing for multiple individual topping combinations for each slice. The slices remain separate from each other during the formation, baking, cooling, and separation processes associated with pizza preparation. Given that the toppings remain free from contact with each other, toppings, as well as oils and flavors therefrom do not transfer to nearby slices. This prevents unintended mixing of ingredients and unintentionally altering of the taste of the slices. Additionally, as slices are cooked individually, each slice maintains its own integrity, throughout the entire pizza preparation process, such that each slice appears as if it were made individually.

An embodiment is directed to a device for baking pizzas. The device has a plurality of predetermined compartments separated by divisions for dividing the pizza into portions. The compartments maintain the integrity of each portion, such that each portion bakes independently of the other portions, even though all of the portions of the pizza are baked simultaneously.

Another embodiment is directed to a method of baking a pizza using a device for baking pizzas. The device has a plurality of predetermined compartments separated by divisions adapted to divide the pizza into portions, the compartments adapted to maintain the integrity of each portion such that each portion bakes independently of the other portions. The device is pressed through an unbaked pizza and into contact with a base. Then the pizza is baked with the device still in place. The device is then separated from the baked pizza, preferably after the pizza has cooled. Removal of the device from the pizza results in individual portions of the baked pizza which are already separated from each other.

### BRIEF DESCRIPTION OF THE DRAWINGS

Attention is now directed to the drawing figures, where like or corresponding numerals indicate like or corresponding components.

FIG. 1A is a perspective view of an embodiment of a pizza press in accordance with this invention.

FIG. 1B is a side view of a segment, representative of the segments of the disclosed device of FIG. 1A.

FIGS. 2A-2C are perspective views of the device of FIG. 1A as used in an example process of making a pizza.

FIG. 2D is a perspective view of the completed pizza of FIG. 2C.

FIG. 3 is a cross section of the device, taken along line III-III of FIG. 2B.

### DETAILED DESCRIPTION OF THE INVENTION WITH REFERENCE TO THE DRAWINGS

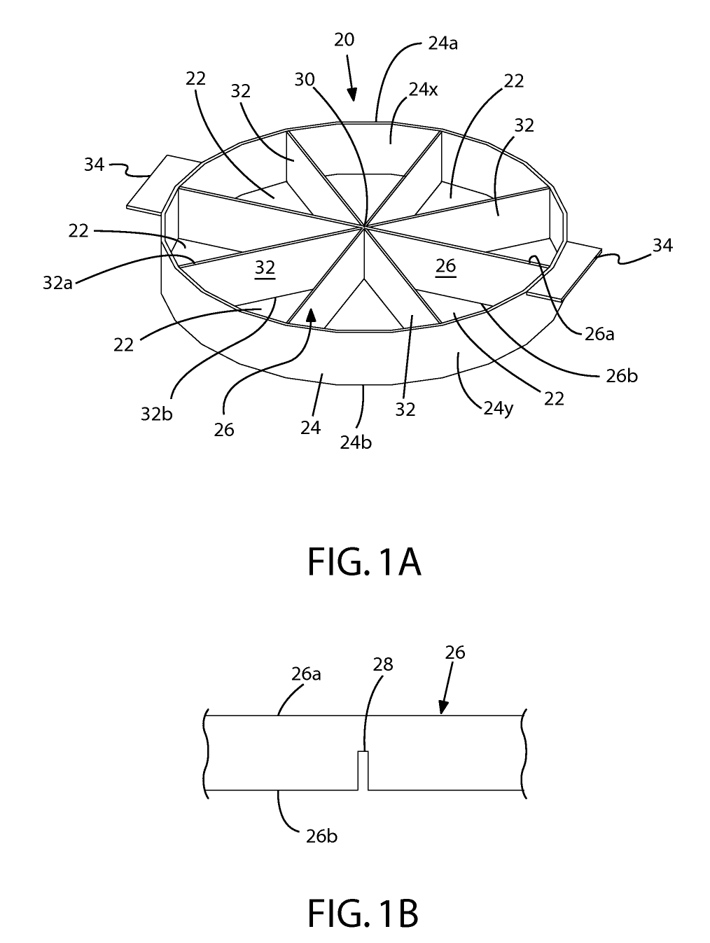

FIG. 1A shows a device 20 for baking pizzas with compartments 22 to facilitate the generation of even-sized slices. The compartments 22 are formed, in part, by a boundary wall 24. In this exemplary embodiment, boundary wall 24 is circular, but other shapes are within the scope of the invention. Diametrically-extending segments 26 attach to the inner surface 24x of the boundary wall 24. A notch 28, of a width slightly greater than the thickness of the segment 26, is at the center of each segment 26, as shown in FIG. 1B. A notch 28 allows segments 26 to cross each other. In this exemplary embodiment, segments 26 cross at a junction 30. In this exemplary embodiment, junction 30 is at the geometric center of the boundary wall 24 of the device 20. The two segments 26 are oriented oppositely and their respective notches 28 are joined together.

Radially-extending segments 32 extend from the inner surface 24x of the boundary wall 24 to the junction 30. These radially-extending segments 32 subdivide the areas between segments 26, to form compartments 22 bounded by boundary wall 24. Handles 34 attach to the outer surface 24y of the boundary wall 24.

The boundary wall 24, segments 26 and 32, and handles 34 are preferably made of food grade stainless steel. Preferably, the boundary wall 24, segments 26 and 32, and handles 34 are permanently fixed in place. This can be accomplished, for example, by welding the parts together. Any other food-safe material, including various types of metal and plastic can be used to form the parts. Additionally, any food-safe joining technique for the aforementioned parts is also within the scope of the invention. The boundary wall 24 and the segments 26 and 32 are preferably approximately two inches (5.08 cm) in height, from upper edge 24a, 26a, 32a to lower edge 24b, 26b, 32b, respectively. Any given notch 28 is preferably at least the width of its corresponding segment 26, and is preferably about one inch (2.54 cm) in height. For example, in FIG. 1B, notch 28 extends about one inch from the lower edge 26b of a segment 26. As mentioned above, the parts of the device are preferably welded into place. Thus, the handles 34 may be welded to the outer surface 24y of boundary wall 24. Other means may be used to affix the handles to the outer surface, such as screws or bolts. Given that the segments 26 and 32 are adapted to be pressed into uncooked dough, rather than through a cooked pizza, the segments 26 and 32 are not sharp or blade-like. In contrast, a sharp blade, being knife-like, would cut through a cooked pizza.

The device 20 is suitable for use in both domestic and commercial kitchens. The material of the device 20 is suitable to withstand temperatures exceeding those of domestic and commercial ovens. Again, stainless steel is the preferable material for the device. The device 20 is also dishwasher-safe. Additionally, the device 20 may be used with cooking oil spray, or other oils, to take on a non-stick property and improve the performance of the device 20 over time. The compartments 22 allow for different pizza topping configurations to be baked independently, but simultaneously, on the same pizza.

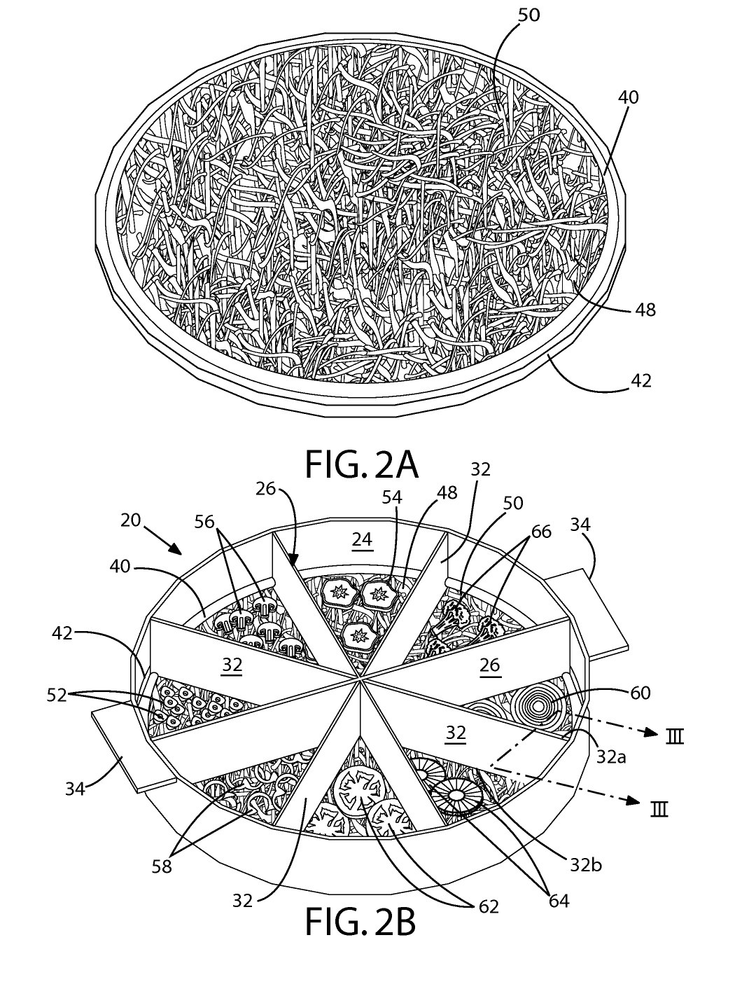

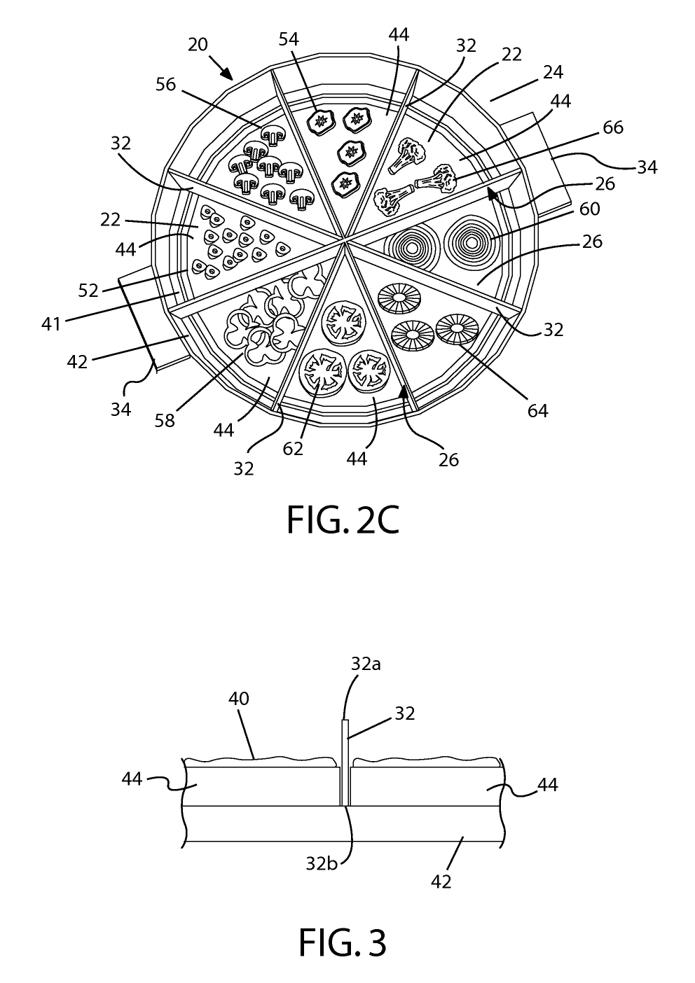

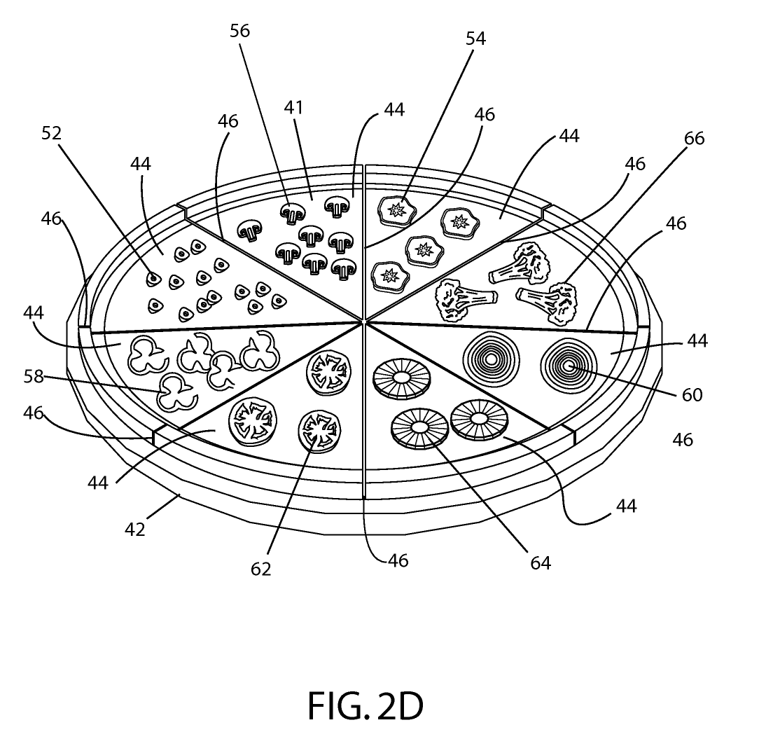

FIGS. 2A-2C depict an exemplary pizza-making operation. Initially, in FIG. 2A the dough 40 is sized to at least approximately conform to the shape of the device 20. Sauce 48 and cheese 50 may be added at this point. The dough 40 typically rests on a baking stone 42. In other embodiments, the baking stone may be replaced with any other conventional baking base, such as a pizza pan or oven bottom.

FIG. 2B shows the device 20 in contact with the dough 40. The device 20 has been pressed into the dough 40, such that the lower edges 24b, 26b, 32b of the boundary wall 24 and segments 26 and 32, respectively, have cut through the dough 40 and are touching the baking stone 42. The contact of the device 20 with the dough 40 and underlying baking stone 42 causes slices 44 to be formed in the dough 40. FIG. 3 provides a cross-sectional view showing a segment 32 pressed through the dough 40 to form slices 44 on either side of the segment 32. The dough 40, shown here with sauce 48 and cheese 50, is compartmentalized, as per compartments 22 of the device 20. The compartments 22 correspond to slices of what will be a cooked pizza, shown as item 41 in FIGS. 2C and 2D. Individualized toppings, such as olives 52, zucchini 54, mushrooms 56, green peppers 58, onions 60, tomato slices 62, pineapple slices 64 and broccoli 66 are added on a compartment-by-compartment basis. The dough 40, sauce 48, cheese 50, and other toppings, 52 through 66, are then baked with the device 20 remaining in contact with the baking stone 42 throughout the baking process.

In FIG. 2C, the cooked pizza 41 and device 20 have been removed from the oven. Preferably, the pizza 41 is left to cool on a counter top or other flat surface. Afterwards, the device 20 is removed from the pizza 41. The individual slices 44 formed by compartments 22 are separated from each other by gaps 46. In other words, there is no need to now cut the pizza 41 into slices, because that task was accomplished by pressing the device 22 into the dough 40 prior to baking.

The complete pizza 41 is shown in greater detail in FIG. 2D. In this figure, the device 20 has been removed from the pizza 41. As can be seen, gaps 46 separate the slices 44 of the pizza 41. With gaps 46 already separating each slice 44, there is no need for a knife or similar instrument to cut a slice 44 away from the pizza 41. Each slice 44 can be easily removed from the baking stone 42, without disruption or contact with the other slices 44.

While eight compartments 22 are shown in the device 20, this is exemplary only. Other embodiments of a device according to the invention may be adapted to have any number of compartments to create any number of slices, based on the combination of segments 26 and 32 used. Additionally, any combination of diametrically-extending segments 26, radially-extending segments 32, or other types of segments may be used. For example, segments may be adapted to generate square or rectangular compartments. Other shapes and combinations of shapes are also within the scope of the disclosed invention. Additionally, the aforementioned segments need not meet at the geometric center of the boundary wall. Further, the boundary wall 24 may be of any shape, not just the circular shape shown in the figures. Such alternative embodiments are preferably made with the materials and techniques discussed with reference to device 20.

While a pizza has been shown, the device and method may be easily adapted by those of skill in the art for other cooked/baked and non-cooked/non-baked food items. While preferred embodiments have been described, so as to enable one of skill in the art to practice the disclosed subject matter, the preceding description is intended to be exemplary only. The preceding description should not be interpreted to limit the scope of the disclosed subject matter. The scope of the disclosed subject matter should be interpreted with reference to the following claims.

What is claimed is:

1. A device for preparing and baking a pizza, comprising:
a boundary wall made of oven-safe, dishwasher-safe, and food-safe material having a lower edge defining a closed curve on a plane;
a plurality of segments of oven-safe, dishwasher-safe, and food-safe material, each segment having edges which are not sharp, the lower edges of the segments being coplanar with the lower edge of the boundary wall, and each segment extending from a position along the boundary wall and meeting with the other segments in the plurality of segments at a junction located at the geometric center of the closed curve, whereby the segments serve to define portions of the pizza and maintain the integrity of each portion, preventing any toppings on the pizza from migrating from one portion to another.

2. The device of claim 1, wherein the closed curve is a circle.

3. The device of claim 1, wherein the device includes at least two handles affixed to opposite sides of the boundary wall.

4. The device of claim 1, wherein the boundary wall and the plurality of segments are made of metal and are welded together.

5. The device of claim 1, wherein the number segments in the plurality of segments is eight.

6. A method of preparing and baking a pizza with a device comprising:
a boundary wall having a lower edge defining a closed shape on a plane;
a plurality segments, each segment having edges, the lower edges of the segments being coplanar with the lower edge of the boundary wall, and each segment extending inward from a position along the boundary wall, the method comprising:
(a) pressing the device through an unbaked pizza and into contact with a base located underneath the unbaked pizza, thereby defining slices of the pizza;
(b) baking the pizza with the device in place; and
(c) separating the device from the pizza.

7. The method of claim 6, further comprising adding at least one topping to at least one slice of the pizza after step (a) but before step (b).

8. The method of claim 7, wherein a topping added to at least one slice of the pizza differs from a topping added to at least one other slice of the pizza.

9. The method of claim 6, further comprising allowing the pizza to cool after step (b) but before step (c).

10. The method of claim 6, wherein the segments meet at a junction at the geometric center of the closed shape.

11. The method of claim 6, wherein the closed shape is a circle.

12. The method of claim 6, wherein the device further comprises at least one handle affixed to the device.

13. The method of claim 12, wherein the at least one handle is affixed to the boundary wall.

14. The method of claim 13, wherein the at least one handle is two handles, affixed to opposite sides of the boundary wall.

15. The method of claim 6, wherein the device is made of metal.

16. The method of claim 15, wherein the device is made of stainless steel.

17. The method of claim 15, wherein the device is welded together.

18. The method of claim 6, wherein the device is made of food-safe, dishwasher-safe, and oven-safe material.

19. The method of claim 6, wherein the edges of each segment are not sharp.

20. A device for preparing and baking a pizza, comprising:
a plurality of compartments separated by divisions adapted to divide the pizza into portions, the compartments being adapted to maintain the integrity of each portion such that each portion bakes independently of the other portions and any toppings on the pizza do not migrate from one portion to another portion.
